(19) United States
(12) Patent Application Publication
(10) Pub. No.: US 2013/0154302 A1
(43) Pub. Date: Jun. 20, 2013

(54) SEALING ELEMENT UNIT

(71) Applicants: Dae Chul KIM, Hwaseong-si (KR); Bum Suk KANG, Ansan-si (KR)

(72) Inventors: Dae Chul KIM, Hwaseong-si (KR); Bum Suk KANG, Ansan-si (KR)

(73) Assignee: Hyundai Motor Company, Seoul (KR)

(21) Appl. No.: 13/529,919

(22) Filed: Jun. 21, 2012

(30) Foreign Application Priority Data
Dec. 14, 2011 (KR) 10-2011-0134870

(51) Int. Cl. E06B 7/22

(52) U.S. Cl. 296/93

(57) ABSTRACT

A sealing member unit may include a fixation portion that has a clip formed at one side thereof to be fixed on a vehicle body; and an elastic change portion of which one side thereof joins the one side of the fixation portion wherein the elastic change portion includes a central portion that is hollow in a length direction of the elastic change portion.

### CROSS-REFERENCE TO RELATED APPLICATION

The present application claims priority to Korean Patent Application No. 10-2011-0134870 filed in the Korean Intellectual Property Office on Dec. 14, 2011, the entire contents of which is incorporated herein for all purposes by this reference.

### BACKGROUND OF THE INVENTION

1. Field of the Invention

The present invention relates to a sealing member unit that is disposed between a vehicle body and a door glass so as to effectively seal a gap between a vehicle body and a door glass, and one side thereof is fixed on the vehicle body.

2. Description of Related Art

A weather strip for a vehicle is a sealing member for a vehicle component. The sealing member is fixed on a vehicle body or an interior of a vehicle and has a function that prevents dust, water, or foreign materials from flowing therein.

The sealing member is disposed between the vehicle body and the door glass, and prevents water leakage, realizes air-tightness for isolating outside noise, prevents vibration of the vehicle body or door glass, and improves comfort.

FIG. 1 is a schematic cross-sectional view of a conventional sealing member unit.

Referring to FIG. 1, a vehicle includes a vehicle body 110, an interior 120, a door glass 100, and a sealing member unit, wherein the sealing member unit includes a body that is fixed on the vehicle body through a clip, and a rib 135 that is integrally formed with the body to have a long and thin shape.

The rib 135 has a predetermined thickness, two ribs 135 are extended in a direction that is formed from the vehicle body 110 to the door glass 100, and the ribs are respectively disposed at an upper side and a lower side thereof.

One end of each rib 135 is connected to the body 110 and the other end thereof is pressed against the surface of the door glass 100 such that the part that is connected to the body is elastically bent so the other part tightly contacts the door glass.

Meanwhile, as shown, the one end of the rib that is connected to the body is bent by a large angle and the bending stress is focused on the one portion to deteriorate the durability, and there is a problem that noise is generated at the other end of the rib.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sealing member unit having advantages of improving overall durability and preventing noise from being generated in a portion contacting a door by distributing stress.

In an exemplary embodiment of the present invention, a sealing member unit, may include a fixation portion that may have a clip formed at one side thereof to be fixed on a vehicle body, and an elastic change portion of which one side thereof joins the one side of the fixation portion wherein the elastic change portion may include a central portion that is hollow in a length direction of the elastic change portion.

The fixation portion further may include a protrusion formed on the other side of the fixation portion to receive a portion of the vehicle body between the clip and the protrusion.

The elastic change portion may include an inner change portion that is formed along an interior circumference of the center portion, and an outer change portion that is formed along an exterior circumference of the inner change portion with a predetermined thickness and is integrally formed with the fixation portion.

The fixation portion is made of an EPDM (Ethylene Propylene Diene Monomer) solid rubber material, wherein the inner change portion of the elastic change portion is made of an EPDM sponge rubber material, and wherein the outer change portion of the elastic change portion is made of the EPDM solid rubber material.

A coating layer is formed on the outer change portion that is formed at an opposite side of the fixation portion in the elastic change portion.

The coating layer is made of flocking.

The coating layer is made of urethane.

The coating layer slides with a surface of a door glass, and the clip of the fixation portion is fixed on the vehicle body.

The clip of the fixation portion is fixed on the vehicle body through a receiving hole formed to the vehicle body.

The fixation portion may include a groove covered with a side of the inner change portion to form a hole therebetween.

The one side of the elastic change portion is fixed to the fixation portion through a first joining portion and a second joining portion, wherein the first joining portion and the second joining portion are formed with a predetermined gap in a direction that the clip is formed.

The present invention for achieving the above object improves the shape of an elastic change portion into a pipe shape having a central hole to improve durability, and it increases the outside surface area that slides with the door glass to maintain sealing capability and reduces wind sound from the outside of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic cross-sectional view of a conventional sealing member unit.

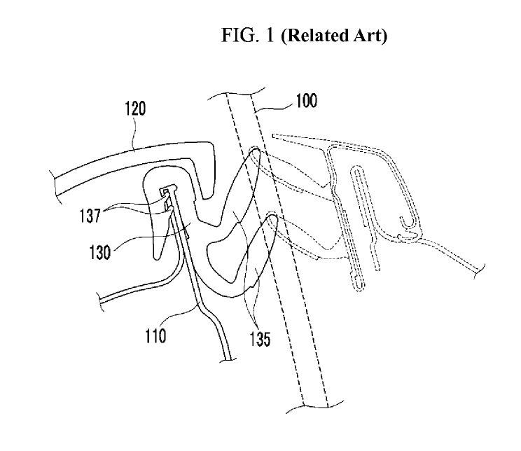

FIG. 2 is a schematic cross-sectional view showing a condition in which a sealing member unit is disposed according to an exemplary embodiment of the present invention.

FIG. 3 is a partial detailed cross-sectional view showing a condition in which a sealing member unit is disposed according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

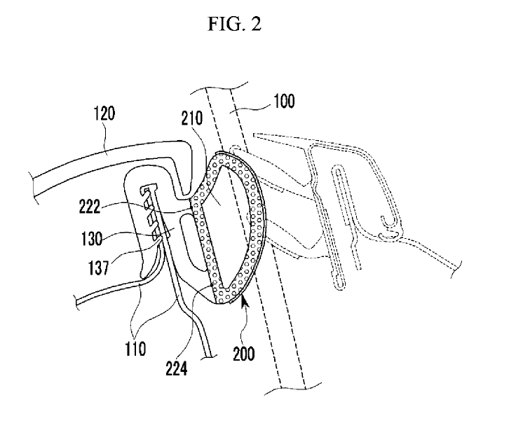

FIG. 2 is a schematic cross-sectional view showing a condition in which a sealing member unit is disposed according to an exemplary embodiment of the present invention.

Referring to FIG. 2, a vehicle includes an interior 120, a vehicle body 110, a door glass 100, and a sealing member unit 130, 137, and 200, and the sealing member unit 130, 137, and 200 includes a clip 137, a fixation portion 130, and an elastic change portion 200.

The fixation portion 130 of the sealing member unit 130, 137, and 200 is fixed on the vehicle body 110 through the clip 137 and a protrusion 139, the clip 137 is disposed at one side based on the fixation portion 130, and the elastic change portion 200 is disposed at an opposite side of the clip 137.

In an exemplary embodiment of the present invention, the vehicle body 110 may include a receiving hole 134 to receive the clip 137 therethrough.

The elastic change portion 200 is fixed on the fixation portion 130 through a first joining portion 222 and a second joining portion 224. As shown, the first joining portion 222 is disposed at an upper side and the second joining portion 224 is disposed at a lower side of the first joining portion 222, that is, they are arranged in a direction that the clip 137 is formed with a predetermined gap.

Further, in FIG. 2 showing a cross-sectional view, the elastic change portion 200 has a pipe shape in which the center portion thereof is hollow in a length direction, and the elastic change portion 200 can be formed in a length direction with a predetermined length.

One side surface of the door glass 100 closely contacts the outside surface of the elastic change portion 200, the overall cross-section of the elastic change portion 200 is elastically transformed, and the outside surface that is formed at an opposite side of the fixation portion 130 closely contacts the door glass 100.

As shown, when the door glass 100 moves up or down, the elastic change portion 200 has a structure such that the overall shape is transformed along a circumference such that stress is not focused on one part but is uniformly distributed along an entire circumference direction. Accordingly, the overall durability is improved compared with a conventional art.

Further, a relatively wide area surface of the elastic change portion closely contacts the door glass to improve sealing capability.

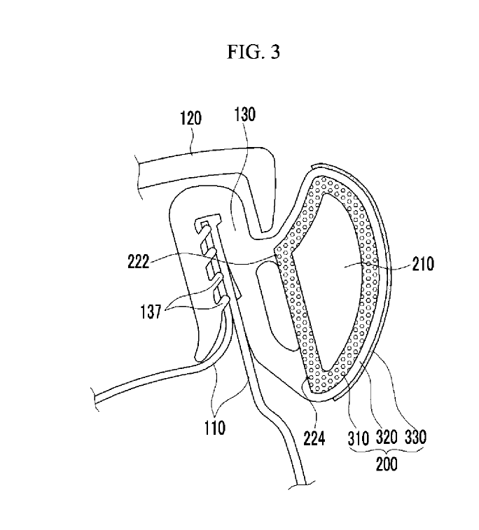

FIG. 3 is a partial detailed cross-sectional view showing a condition in which a sealing member unit is disposed according to an exemplary embodiment of the present invention.

FIG. 3 shows details of a portion of FIG. 2. Referring to FIG. 3, the sealing member unit 130, 137, and 200 includes the fixation portion 130 that is fixed on the vehicle body 110 between the clip 137 and the protrusion 139 and the elastic change portion 200 that is fixed on the fixation portion 130 through the first joining portion 222 and the second joining portion 224.

Further, the elastic change portion 200 includes an inner change portion 310, an outer change portion 320, and a coating layer 330.

The inner change portion 310 has a predetermined thickness that is formed along an interior circumference of the elastic change portion 200. As shown, the cross-section thereof has a pipe structure with a central portion 210 that is hollow.

The outer change portion 320 covers the outside surface of the inner change portion 310 with a predetermined thickness, and the outer change portion 320 is not formed between the first joining portion 222 and the second joining portion 224.

In an exemplary embodiment of the present invention, the fixation portion includes a groove 240 covered with the inner change portion 310 to form a hole between the fixation portion 130 and the inner change portion 310 to increase flexibility of the elastic chamber portion 200.

The coating layer 330 is thinly formed on the outside surface of the outer change portion 320 at an outside surface of an opposite side of the first joining portion 222 and the second joining portion 224. The coating layer 330 is substantially formed on a part that slides with one side surface of the door glass 100.

In an exemplary embodiment of the present invention, the fixation portion 130 is made of an EPDM (Ethylene Propylene Diene Monomer) solid rubber material, the inner change portion 310 of the elastic change portion 200 is made of an EPDM sponge rubber material, and the outer change portion 320 of the elastic change portion 200 is made of the EPDM solid rubber material.

The fixation portion 130 and the outer change portion 320 are made of the same material, wherein the outer change portion 320 has a thin layer structure to be elastically transformed. In a condition in which the outer change portion 320 and the fixation portion 130 are formed, the inner change portion 310 is formed along an interior circumference thereof and the coating layer 330 can be formed on the outer change portion 320.

Further, the coating layer 330 can be formed by a flocking process or can be formed by coating urethane in an exemplary embodiment of the present invention. Accordingly, the durability of the coating layer 330 that slides with the door glass 100 is improved to reduce noise that can be generated from the sliding.

That is, the shape of the elastic change portion 200 has a pipe structure having a hollow central portion 210 to improve the durability, and the area of the outside surface that slides relative to the door glass 100 is increased to maintain the sealing capability and reduce noise that can be generated from outside of the vehicle, even when the vehicle is deteriorated.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sealing member unit, comprising:
a fixation portion that has a clip formed at one side thereof to be fixed on a vehicle body; and
an elastic change portion of which one side thereof joins the one side of the fixation portion wherein the elastic change portion includes a central portion that is hollow in a length direction of the elastic change portion.

2. The sealing member unit of claim 1, wherein the fixation portion further includes a protrusion formed on the other side of the fixation portion to receive a portion of the vehicle body between the clip and the protrusion.

3. The sealing member unit of claim 1, wherein the elastic change portion includes:
an inner change portion that is formed along an interior circumference of the center portion; and
an outer change portion that is formed along an exterior circumference of the inner change portion with a predetermined thickness and is integrally formed with the fixation portion.

4. The sealing member unit of claim 3,
wherein the fixation portion is made of an EPDM (Ethylene Propylene Diene Monomer) solid rubber material,
wherein the inner change portion of the elastic change portion is made of a EPDM sponge rubber material, and
wherein the outer change portion of the elastic change portion is made of the EPDM solid rubber material.

5. The sealing member unit of claim 3, wherein a coating layer is formed on the outer change portion that is formed at an opposite side of the fixation portion in the elastic change portion.

6. The sealing member unit of claim 5, wherein the coating layer is made of flocking.

7. The sealing member unit of claim 6, wherein the coating layer is made of urethane.

8. The sealing member unit of claim 5, wherein the coating layer slides with a surface of a door glass, and the clip of the fixation portion is fixed on the vehicle body.

9. The sealing member unit of claim 8, wherein the clip of the fixation portion is fixed on the vehicle body through a receiving hole formed to the vehicle body.

10. The sealing member unit of claim 1, wherein the fixation portion includes a groove covered with a side of the inner change portion to form a hole therebetween.

11. The sealing member unit of claim 1, wherein the one side of the elastic change portion is fixed to the fixation portion through a first joining portion and a second joining portion, wherein the first joining portion and the second joining portion are formed with a predetermined gap in a direction that the clip is formed.
